(19) United States
(12) Patent Application Publication
(10) Pub. No.: US 2006/0253425 A1
(43) Pub. Date: Nov. 9, 2006

(54) Evaluation and pricing of user interactions with online advertisements

(75) Inventors: Christian H. Borgs, Seattle, WA (US); Jennifer T. Chayes, Seattle, WA (US); Uriel M. Feige, Bellevue, WA (US); Mohammad Mahdian, Bellevue, WA (US); Nicole S. Immorlica, Mont Vernon, NH (US); Amin Saberi, Palo Alto, CA (US); Joshua T. Goodman, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/121,405

(22) Filed: May 4, 2005

(51) Int. Cl. G06F 17/30

(52) U.S. Cl. 707/3

(57) ABSTRACT

The subject invention employs an indication gateway to provide a “buffer” between user indications (e.g., “clicks”) responsive to an interactive enticement such as, for example, a clickable online advertisement, and an entity associated with the enticement such as, for example, an online business. The indication gateway allows for subsequent checks on whether an initial user indication is sincere. Instances of the subject invention can accomplish this via additional information gathering, subsequent indication requirements, fraudulent indication tests, and/or buffering of subsequent indications, links, & content and the like. Additionally, instances of the subject invention can differentiate between different types of user indications and provide pricing structures based upon the differentiated types. This facilitates in providing a charging process for user indications to entities associated with the interactive enticement.

### TECHNICAL FIELD

The subject invention relates generally to user interactions with enticements, and more particularly to systems and methods for evaluating and/or pricing of user indications that are responsive to an interactive enticement.

### BACKGROUND OF THE INVENTION

Modem society has come to depend heavily on computers and computer technology. It is especially prevalent in the business arena where companies compete fiercely for customers and product sales. A company with just-in-time inventory and well focused advertising strategies generally produces a product cheaper and delivers it faster to a customer than a competitor. Computer technology makes this type of business edge possible by networking businesses, information, and customers together. Although originally computers communicated to other computers via networks that only consisted of local area networks (LANs), the advent of the Internet has allowed virtually everyone with a computer to participate in a global network. This allows small businesses to be competitive with larger businesses without having to finance and build a network structure.

As computing and networking technologies become more robust, secure and reliable, more consumers, wholesalers, retailers, entrepreneurs, educational institutions and the like are shifting paradigms and employing the Internet to perform business instead of the traditional means. Many businesses are now providing websites and on-line services. For example, today a consumer can access his/her account via the Internet and perform a growing number of available transactions such as balance inquiries, funds transfers and bill payment.

Moreover, electronic commerce has pervaded almost every conceivable type of business. People have come to expect that their favorite stores not only have brick and mortar business locations, but that they can also be accessed “online,” typically via the Internet's World Wide Web (WWW). The Web allows customers to view graphical representations of a business' store and products. Ease of use from the home and convenient purchasing methods, typically lead to increased sales. Buyers enjoy the freedom of being able to comparison shop without spending time and money to drive from store to store.

Advertising in general is a key revenue source in just about any commercial market or setting. To reach as many consumers as possible, advertisements are traditionally presented via billboards, television, radio, and print media such as newspapers and magazines. However, with the Internet, advertisers have found a new and perhaps less expensive medium for reaching vast numbers of potential customers across a large and diverse geographic span. Advertisements on the Internet can primarily be seen on web pages or websites as well as in pop-up windows when a particular site is visited.

In addition to such generic website advertising, businesses interested in finding new customers and generating revenues continue to look for atypical channels that may be suitable for posting advertisements. One alternate delivery mode, for example, involves attaching an advertisement to an incoming email for the recipient of the email to view. The type or subject matter of the advertisement may be selected according to text included in the body of the message.

Thus, global communication networks such as the Internet have presented commercial opportunities for reaching vast numbers of potential customers. In the past several years, vast amounts of users have turned to the Internet as a reliable source of news, research resources, and various other types of information. In addition, online shopping, making dinner reservations, and buying concert and/or movie tickets are just a few of the common activities currently conducted while sitting in front of a computer by way of the Internet. However, the widespread use of the Internet by businesses as well as private consumers can lead to unwanted or even undesirable exposure to a variety of economic risks and/or security weaknesses.

With respect to online businesses, security and the validity of buyers making online purchases or reservations have become main concerns. For example, many restaurants provide an online reservation service wherein customers can make their reservations via the Internet using the restaurants' websites. Unfortunately, this system makes restaurant owners somewhat vulnerable to automated script attacks that make fraudulent reservations. Such attacks occur when a computer makes several hundred, if not more, fake online reservations affecting a large number of restaurants. As a result of such an attack, these businesses can be interrupted or even damaged due to loss revenues, system repairs and clean-up costs, as well as the expenses associated with improving network security.

Businesses that advertise can also be subject to such fraudulent attacks. Generally, a business is charged “per click” for their advertisement on a Web page. If a script is utilized to “click” that advertisement several thousand times, the business is charged for those clicks even though they were fraudulent clicks. Competitors have an incentive to create these fraudulent clicks, which can drive the victim out of the competition for clicks, and, in auction-based systems, lower the required winning bid. Click fraud is currently a substantial problem. Currently, it is not always possible to know if a click is legitimate or not. Additionally, a user might accidentally click on an advertisement with no real intention of pursuing further information or purchasing a product. However, the business must still pay for this “click” regardless of whether the user actually meant to proceed to the businesses website. The extra costs associated with these types of “clicks” become astronomical when the size of the Internet is considered. It would be highly desirable to eliminate these types of clicks and only have businesses pay for clicks that produce some type of positive result. It would also be desirable to be able to determine the user's intent and charge accordingly.

In particular, advertisers prefer models such as pay-per-conversion in which they are charged for advertising when they make a sale, rather than when a click generates traffic to their site. However, suppliers of advertising generally do not like pay-per-conversion for three reasons. First, conversions are much less common than clicks, so estimating important numbers, such as the probability that by showing an ad the supplier obtains revenue, becomes difficult because of data sparsity. Second, pay-per-conversion makes the supplier very dependent on the advertiser's site: if the advertiser charges too much for each conversion, the supplier makes no money on the conversions. Third, pay-per-conversion requires that the supplier trust the advertiser to accurately report conversions, while the advertiser has an obvious incentive to under-report. It is thus desirable to find techniques that can be thought of as compromises between pay-per-click and pay-per conversion, with some of the desirable properties of both.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates generally to interactive advertisements, and more particularly to systems and methods for evaluating and/or pricing of user indications that are responsive to an interactive enticement. An indication gateway is utilized to provide a “buffer” between user indications (e.g., “clicks”) responsive to an interactive enticement such as, for example, a clickable online advertisement, and an entity associated with the enticement such as, for example, an online business. The indication gateway allows for subsequent checks on whether an initial user indication is sincere. Instances of the subject invention can accomplish this via additional information gathering, subsequent indication requirements, fraudulent indication tests, and/or buffering of subsequent indications, links, & content and the like. Additionally, instances of the subject invention can differentiate between different types of user indications and provide pricing structures based upon the differentiated types. This facilitates in providing a charging process for user indications to entities associated with the interactive enticement. Thus, instances of the subject invention significantly enhance the value of sincere user indications versus insincere and/or fraudulent user indications, allowing premium charges for those indications that bring positive impact to an enterprise.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of an indication gateway system in accordance with an aspect of the subject invention.

FIG. 2 is another block diagram of an indication gateway system in accordance with an aspect of the subject invention.

FIG. 3 is a flow diagram of a method of charging for interactions with an enticement in accordance with an aspect of the subject invention.

FIG. 4 is a flow diagram of a method of preventing fraudulent activity associated with interacting with an enticement in accordance with an aspect of the subject invention.

FIG. 5 is a flow diagram of a method of providing buffering of information in response to a user interaction with an enticement in accordance with an aspect of the subject invention.

FIG. 6 illustrates an example operating environment in which the subject invention can function.

FIG. 7 illustrates another example operating environment in which the subject invention can function.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

Instances of the subject invention provide an indication gateway to intercede between user indications and an entity associated with an interactive enticement. In this manner, initial user indications can be tested to determine if the user is sincere. This allows insincere indications to be blocked and/or redirected and the like. It also permits user indications to be typed such that different indication types can be utilized in a pricing structure for charging entities associated with the interactive enticement. The user indications include, but are not limited to, mouse and/or keyboard clicks and other user actions and the like as described infra. The interactive enticement can include, but is not limited to, online clickable advertisements and the like. However, other instances of the subject invention can also be utilized with advertisements embedded in emails and the like. An interactive enticement is typically a device to encourage interaction with a user and can include non-advertising and non-online devices as well.

For example, many search engines or content providers place advertisements (i.e., interactive enticements) on their pages and charge the advertisers based on the number of times their advertisement is clicked. In many situations, a click (i.e., a user indication) on an advertisement is not because of a genuine interest of a user (i.e., the indication is not “sincere”). Users might accidentally click on advertisements and/or fraudulently click on a specific advertisement to increase the advertisement cost of a business. Thus, instances of the invention provide systems and methods for reducing the number of accidental and/or fraudulent clicks on advertisements placed on search and/or content pages on the World Wide Web. The advertiser can be charged if the user does something more than just, for example, the first click on the advertisement. The user can be directed to a second page and be directed to the advertiser's web page only after clicking on a button and/or a hyperlink on the second page. For charging the advertiser, the search engine and/or the content provider can take into consideration the number of clicks on the second page as well as the first page. In other instances of the subject invention, the second page can also request additional information that can be utilized to determine sincerity and/or sold to the entity associated with the interactive enticement.

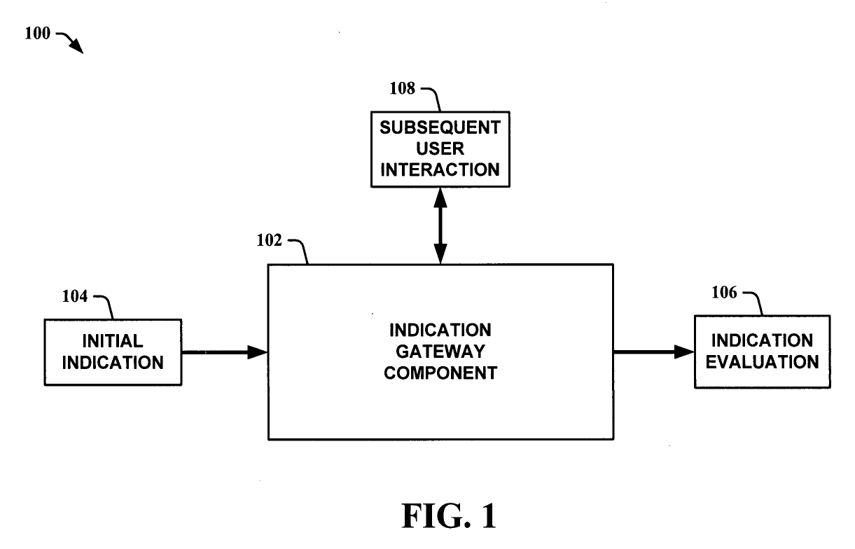

In FIG. 1, a block diagram of an indication gateway system 100 in accordance with an aspect of the subject invention is shown. The indication gateway system 100 is comprised of an indication gateway component 102 that receives an initial indication 104 and utilizes subsequent user interaction 108 to provide an indication evaluation 106. The initial indication 104 can be a user action such as a “click” from an input device, including, for example, a keyboard and/or a mouse and the like. One skilled in the art can appreciate that other input devices currently existing and/or input devices yet to exist, can be utilized and are within the scope of the subject invention. For example, technologies are being developed to determine eye movement, thought processing, and/or body movement and the like as input determinants. Biometric devices can also be utilized with the subject invention such as, for example, fingerprinting devices, DNA devices, and/or retinal scanning devices and the like. User indications can also include inputs that utilize other means such as voice and/or movement and the like. Likewise, the subsequent user interaction 108 can utilize these methods of input as well.

The indication gateway 102 intercepts the initial indication 104 that is in response to an interactive enticement. The interactive enticement can be, for example, an online clickable advertisement that takes a user to an entity's (e.g., business') website. It can also be an interactive advertisement in an email and the like. Thus, the subject invention is not limited to only online advertisements. The interactive enticement can also be a non-visual enticement as well. Thus, for example, an audio advertisement can end with “Just say ‘dog’ and we'll take you to our website.” When the user says “dog” (i.e., the user indication), the indication gateway 102 intercedes to determine the sincerity of the user indication. For example, the indication gateway 102 can intercede with an additional audio message that says “Did you mean to say ‘cat’?” and impede transportation to the website until an appropriate reply is given. By changing the question and, thus, the response, it can filter out automatic response devices by developing questions that require additional thought beyond a simple reply. Similarly, the user can be asked for additional information to determine sincerity and/or simply requested to perform addition user indications such as clicking on dynamic point on a screen, completing a human interface test (e.g., entering codes found in distorted pictures of the codes). The indication gateway 102 can also be utilized to partially and/or completely buffer subsequent user interaction from an entity and/or to permit tracking of the user.

The indication evaluation 106 is based upon the determinations made by the indication gateway 102 as noted supra. It 106 can be utilized to determine pricing structures and the like. Typically, the indication evaluation 106 is representative of a type of user indication. For example, it 106 can be simply a sincere or insincere type with regard to the initial indication 104. Thus, an entity can be charged for only the sincere type of initial indication and/or charged based on whether or not subsequent user indications occurred (e.g., follow up clicks and/or responses from the user). In yet other instances of the subject invention, the indication evaluation 106 is utilized to prevent user indication fraud. Thus, the indication evaluation 106 can be utilized, for example, so that only valid user indications are passed on to the entity associated with the interactive enticement.

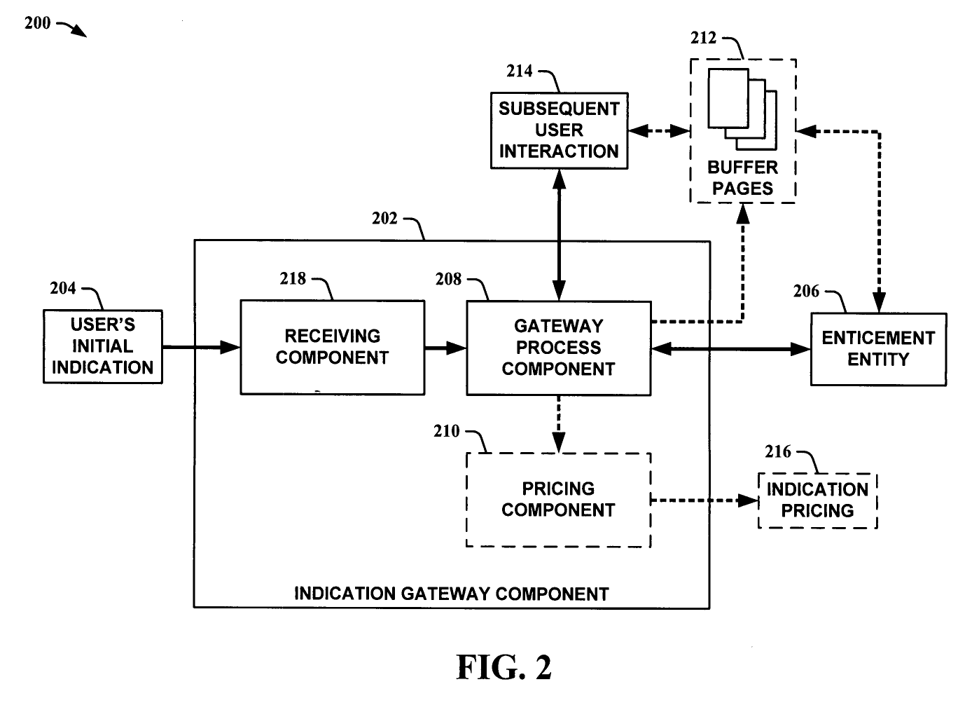

Turning to FIG. 2, another block diagram of an indication gateway system 200 in accordance with an aspect of the subject invention is depicted. The indication gateway system 200 is comprised of an indication gateway component 202 that receives a user's initial indication 204 and subsequent user interaction 214 and interacts with an enticement entity 206 (e.g., an online business advertising an item for sale). Optionally, the indication gateway component 202 can provide buffer pages 212 and indication pricing 216. The indication gateway component 202 is comprised of a receiving component 218, a gateway process component 208, and an optional pricing component 210. The receiving component 218 receives the user's initial indication 204. The gateway process component 208 then receives the user's initial indication 204 from the receiving component 218. In other instances of the subject invention, the gateway process component 208 can directly receive the user's initial indication 204.

In this manner, the gateway process component 208 intercepts the user's initial indication 204 before it 204 is passed to the enticement entity 206. The enticement entity 206 can be, for example, the providing entity of the enticement and/or a representative entity for the enticement. Thus, interacting with third parties is within the scope of the subject invention. The gateway process component 208 facilitates in determining the sincerity of the user's initial indication 204. This can be accomplished, for example, as described supra, such as utilizing subsequent user interaction 214. These interactions 214 can include requesting additional responsive clicks from a user, requesting additional information from a user, requesting the user to decipher a coded visualization, and/or other types of object recognition and the like. Other means of filtering out fraud, “bots,” and/or automated devices work as well such as having a user click on a dynamic target and the like. In some instances of the subject invention, buffer pages 212 can be provided to the user for additional interactions and/or to accomplish the prior methods. The enticement entity 206 can also interact with the buffer pages 212 to provide updated content and the like. Thus, when a user's initial indication is received, the gateway process component 208 can initiate a web page to be displayed to the user asking for additional information and/or indications (e.g., clicks).

In other instances of the subject invention, the gateway process component 208 can buffer the enticement entity 206 partially and/or wholly by intercepting all subsequent indications from a user. Thus, the gateway process component 208 can employ redirecting, funneling, and/or complete hosting of information from the enticement entity 206. This permits the gateway process component 208 to track the user's subsequent activity and accurately track the sincerity of the user's indications. For example, if a user “clicks through” until a purchase is desired, the gateway process component 208 can assign a higher value to that type of click. This facilitates in accurately assessing and charging for different types of sincerity with regard to a user's actions (i.e., indications). An indication that delivers a purchase is generally valued much higher than a casual interest indication.

Thus, in some instances of the subject invention, the optional pricing component 210 receives sincerity evaluations for the user indications from the gateway process component 208 and establishes a pricing schedule that facilitates in charging the enticement entity 206 for responsiveness to the interactive enticement. The user indications are then assessed a price and the indication pricing 216 is provided. One skilled in the art can appreciate that the indication gateway system 200 can be utilized to facilitate existing systems that automatically and/or manually charge for advertisement interactions and the like.

To give one example, an advertising supplier, such as OnlineSearchEngine.com might provide advertisements for an online business enticement entity, such as OnlineBookseller.com. Receiving component 218, gateway process component 208, and pricing component 210, would all be owned or controlled by OnlineSearchEngine.com. When clicking on an ad in the search engine, the user's interaction would be delivered to the receiving component 218. The user would be presented by a web page, whose HTML content would be delivered from the buffer pages, 212. The buffer pages 212 were supplied by the enticement entity, but because they are actually delivered to the user by the advertising supplier, the advertising supplier can monitor this interaction. The user could interact with one or more pages from the buffer pages until his interaction was shifted over directly to the enticement entity, e.g., to make the final sale. The enticement entity would be billed by the advertising supplier based on the interactions observed by the advertising supplier.

For example, instances of the subject invention are substantially beneficial to interactive enticements (e.g., advertisements) found online. Many search engines and/or content providers place advertisements on their pages and charge the advertisers based on the number of clicks their advertisement receives. However, a single click received based on a small advertisement amidst a search page does not necessarily represent serious interest on the part of the user. Such clicks could indicate that the user is simply seeking additional information regarding the advertiser or could be the result of an accidental or even a fraudulent click. Clearly, advertisers value clicks from serious users more highly than those from casual browsers and want to prevent being charged for accidental or fraudulent clicks. Instances of the subject invention facilitate advertisers to distinguish casual, accidental and/or fraudulent clicks from serious ones and allow them to differentiate between these clicks in their pricing policies. Instances of the subject invention also allow the advertiser to collect additional information from the user.

In one instance of the subject invention, an indication gateway is provided that allows advertisers to gauge the intent of a user by having the user perform extra clicks, provide additional information, and/or pass additional checks. For example, the first click might direct the user to an informational page designed by the advertiser. If a user maintains interest in the advertiser after viewing this informational page, they can continue to the advertiser's web page via a second click from a hyperlink on this page. This process can also be continued through more than one additional page, although one additional page is typically sufficient. And/or, the user can be required to do more than just click, e.g., they can be directed to enter additional information before clicking, and/or they may be required to recognize and retype a distorted visual representation of a word and/or recognize a picture to ensure that the clicks are being performed by a human, etc. These additional steps provide useful information to the advertiser and/or prevent fraudulent clicks. Each of these additional information pages can be served, for example, by a search engine and/or content provider and the like, enabling the website to track the additional clicks. This allows the advertiser to pay a different amount for each of the clicks. This also enables a search engine and/or content provider to provide more useful customers to the advertiser and, therefore, improve reliability of billing and the advertiser's satisfaction.

In another instance of the subject invention, a mechanism for charging advertisers differently for clicks of varying intent is provided. In this instance, the advertiser is charged when the user does something more than one click on the advertisement (e.g., a second click, filling out a form, recognizing a distorted image and/or some other way protecting against automated clicks, etc.). Thus, providing a click differentiation and pricing system.

For example, after clicking on the advertisement, a user is directed to an informational page, designed by the advertiser but hosted by the content provider. If a user maintains interest in the advertiser after viewing this informational page, a second click will transfer the user to the advertiser's own website (perhaps after filling out an order form, recognizing a distorted image, etc.). Since the informational page is hosted by the content provider, the content provider can keep track of the number of users that click on a link in this page. The amount that the search engine and/or the content provider charges the advertiser can be a function of the number n₀ of impressions or times the advertisement is displayed, the number n₁ of initial clicks it receives, and the number n₂ of times a user has clicked on a hyperlink, filled out a form, recognized a distorted image, etc. on the informational page as follows:
price=p₀n₀+p₁n,₁+p₂n₂, (Eq. 1)
where p₀ is the price per impression, p₁ is the price per initial click, and p₂ is the price per secondary click. These prices can be computed utilizing an auction and/or any other mechanism. The prices can also be zero for those clicks deemed to not have value for a particular advertiser. One skilled in the art can appreciate that other pricing algorithms can be employed and are within the scope of the subject invention.

Other instances of the subject invention buffer an interactive enticement entity by completely hosting its information, redirecting links to its information, and/or funneling links associated with its information and the like. This allows various graduations between traditional pay-per-click means and pay-per-conversion means. Additionally, instances of the subject invention can be employed to “n levels deep.” This allows, for example, advertisers (i.e., enticement entities) to regulate the degree of influence the subject invention has on their website. If the advertiser highly values information entered by a customer on an order page and does not wish to share this information, the hosting/redirecting/funneling, etc. can be halted just prior to when a user clicks on a link to the order page. This also allows for varying degrees of accuracy for the user indications in exchange for various levels of trust. A content provider can assume that if a user clicks on an order page that an order will be processed, and the content provider can charge a higher price for that click to the advertiser. The advertiser might be willing to accept this assumption in order to preserve the confidentiality of the user's ordering information. On the other hand, a smaller advertiser might actually prefer that, for example, the content provider handle all user indications and entered information, because they are not equipped to process it. Thus, instances of the subject invention provide scalability of the charging process.

One instance of the subject invention utilizes funneled links to facilitate user indication tracking. For example, a search page, “examplesearch.com” is utilized by a user to find some information. An advertisement from Company “X” is displayed on the search result page. When the user clicks on the advertisement for Company “X,” they are brought to a web page, “http://www.examplesearchFunnel.com/x.com/pagel.htm.” ExamplesearchFunnel.com retrieves the HTML code for “x.com/pagen.htm” from x.com, which it then displays to the user. Before displaying this, it also translates all links of the form “pagen.htm” to links of the form “http://www.examplesearchFunnel.com/x.com/pagen.htm.” Thus, the user is always browsing through “examplesearchFunnel.com.” In this way, “examplesearch.com” can monitor all links clicked. Instances of the subject invention can do this up to “n-levels deep,” and follow rules determined by “x.com” (e.g., don't redirect links that use secure HTTP). An advantage of this is that it can be extended to n-levels deep, including dynamically generated content like search results. These instances do not require “x.com” to make any changes to their website, or to notify “examplesearch.com” of changes.

Another instance of the subject invention utilizes redirected links to facilitate user indication tracking. When a user clicks on an advertisement for Company “X” on an “examplesearch.com” web page, the user is brought to a page hosted by Company “X,” e.g., “http://x.com/pagel.htm.” All of the links on this page are of the form “http://www.examplesearchRedirect.com/x.com/pagen.htm.” This is a special link that goes through “examplesearchRedirect.com” which then does a page redirection to “http://x.com/pagen.htm.” Examplesearch.com, for example, can verify by random inspection that Company “X” follows the predetermined rules for evaluating indications. Another advantage is that the user is clearly browsing at “x.com” instead of browsing at “examplesearch.com.” Additionally, the website does not have to rely on “examplesearch.com” to do content updates.

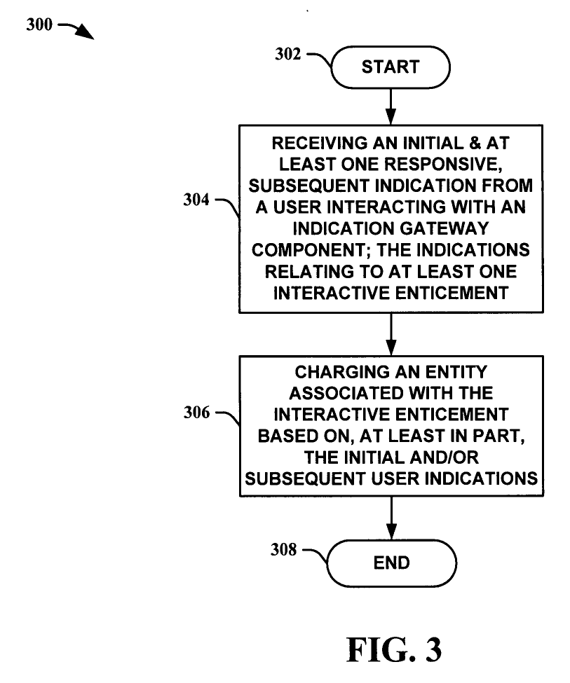

In view of the exemplary systems shown and described above, methodologies that may be implemented in accordance with the subject invention will be better appreciated with reference to the flow charts of FIGS. 3-5. While, for purposes of simplicity of explanation, the methodologies are shown and described as a series of blocks, it is to be understood and appreciated that the subject invention is not limited by the order of the blocks, as some blocks may, in accordance with the subject invention, occur in different orders and/or concurrently with other blocks from that shown and described herein. Moreover, not all illustrated blocks may be required to implement the methodologies in accordance with the subject invention.

The invention may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the subject invention.

In FIG. 3, a flow diagram of a method 300 of charging for interactions with an enticement in accordance with an aspect of the subject invention is shown. The method 300 starts 302 by receiving an initial and at least one responsive subsequent indication from a user interacting with an indication gateway component, the indications relating to at least one interactive enticement 304. The initial and subsequent indications can include, but are not limited to, a user “click” from an input device such as, for example, a keyboard and/or a mouse and the like. One skilled in the art can appreciate that other input devices currently existing and/or input devices yet to exist, can be utilized and are within the scope of the subject invention. For example, technologies are being developed to determine eye movement, thought processing, and/or body movement and the like as input determinants. Biometric devices can also be utilized with the subject invention such as, for example, fingerprinting devices, DNA devices, and/or retinal scanning devices and the like. User indications can also include inputs that utilize other means such as voice and/or movement and the like.

The interactive enticement can be, for example, an online clickable advertisement that takes a user to an entity's (e.g., business') website. It can also be an interactive advertisement in an email and the like. Thus, the subject invention is not limited to only online advertisements. The interactive enticement can also be a non-visual enticement as well as described supra. The indication gateway component interacts in response to the initial indication and can, for example, interact with the user for additional information, additional indications, and/or to test for fraudulent conditions and the like as described supra. The indication gateway component can also be utilized to partially and/or completely buffer subsequent user interaction from an entity and/or to permit tracking of the user.

An entity associated with the interactive enticement is then charged based on, at least in part, the initial and/or subsequent user indications 306, ending the flow 308. Instances of the subject invention can utilize mechanisms for charging based on, for example, charging advertisers differently for indications of varying intent. In this instance, the advertiser is charged when the user interacts with more than one indication with regard to an enticement (e.g., a second indication, filling out a form, recognizing a distorted image and/or some other way protecting against automated clicks, etc.). Thus, providing an indication differentiation and pricing method. Another specific instance of the subject invention includes, but is not limited to, charging based on a function of the number n₀ of impressions or times an enticement is displayed, the number n₁ of initial indications it receives, and the number n₂ of times a user has given indications on an enticement, filled out a form, recognized a distorted image, etc. on the informational page as follows:
price=p₀n₀+p₁n₁+p₂n₂, (Eq. 1)
where p₀ is the price per impression, p₁ is the price per initial indication, and p₂ is the price per subsequent indication. These prices can be computed utilizing an auction and/or any other mechanism. One skilled in the art can appreciate that other pricing algorithms are employable as well and are within the scope of the subject invention.

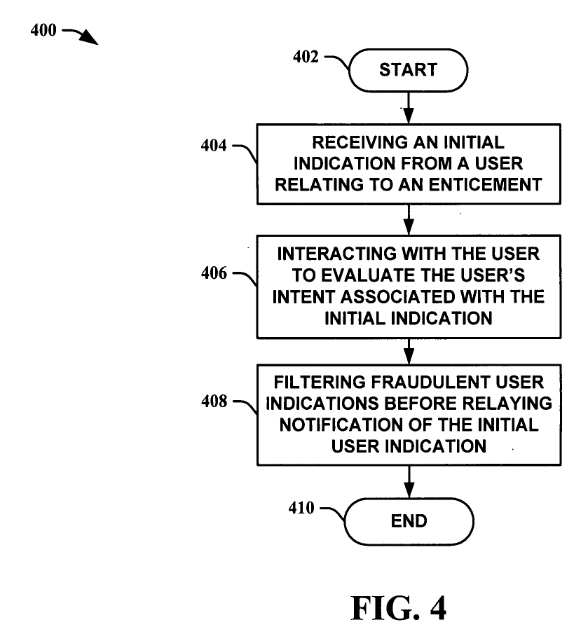

Turning to FIG. 4, a flow diagram of a method 400 of preventing fraudulent activity associated with interacting with an enticement in accordance with an aspect of the subject invention is depicted. The method 400 starts 402 by receiving an initial indication from a user relating to an enticement 404. An initial indication includes, but is not limited to, user actions such as mouse and/or keyboard clicks and the like, including indications as described supra. Interactive enticements include, but are not limited to, online advertisements on web pages and the like, including those described supra. User interaction is then utilized to evaluate the user's intent associated with the initial indication 406. The interactions can include, but are not limited to, requesting additional information from a user, requiring subsequent indications to determine intent of a user, requiring a user to interact with a dynamic web page (e.g., clicking on a moving/dynamic spot), entering information from a distorted figure, identifying objects, and/or simply indicating that they wish to continue to gain additional enticement information and the like. Fraudulent user indications are then filtered out before relaying notification of the initial user indication 408, ending the flow 410. In other instances of the subject invention, the non-fraudulent indications are tracked and/or priced according to their value as positive indications.

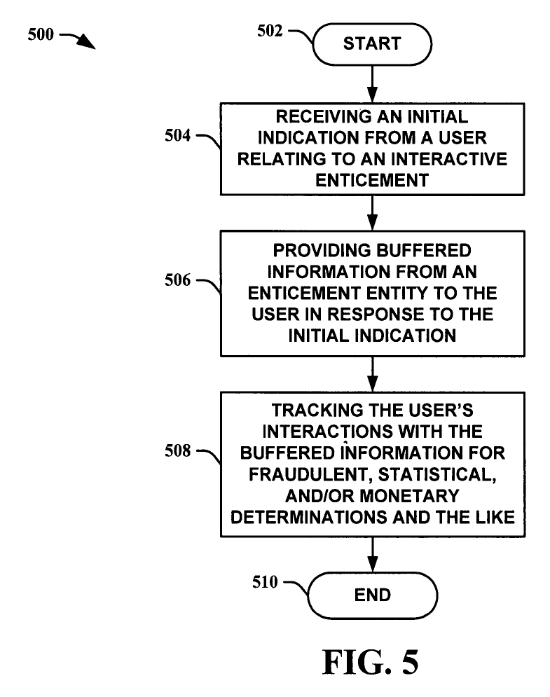

Looking at FIG. 5, a flow diagram of a method 500 of providing buffering of information in response to a user interaction with an enticement in accordance with an aspect of the subject invention is illustrated. The method 500 starts 502 by receiving an initial indication from a user relating to an interactive enticement 504. An initial indication includes, but is not limited to, user actions such as mouse and/or keyboard clicks and the like, including indications as described supra. Interactive enticements include, but are not limited to, online advertisements on web pages and the like, including those described supra. Buffered information from an enticement entity is then provided to the user in response to the initial indication 506. Instances of the subject invention include, but are not limited to, buffered information utilized to provide additional interactions with the user (e.g., for gathering additional information, to request further indications, etc.) and/or utilized to allow continued user enticement interactions (e.g., funneling, redirecting, and/or hosting) and the like as described supra. The user's interactions with the buffered information are then tracked for fraudulent, statistical, and/or monetary determinations and the like 508, ending the flow 510. Thus, instances of the subject invention can provide increased security, traffic flow statistics, and/or valuations that enable enhanced charging structures that better capture a user's intent and the like.

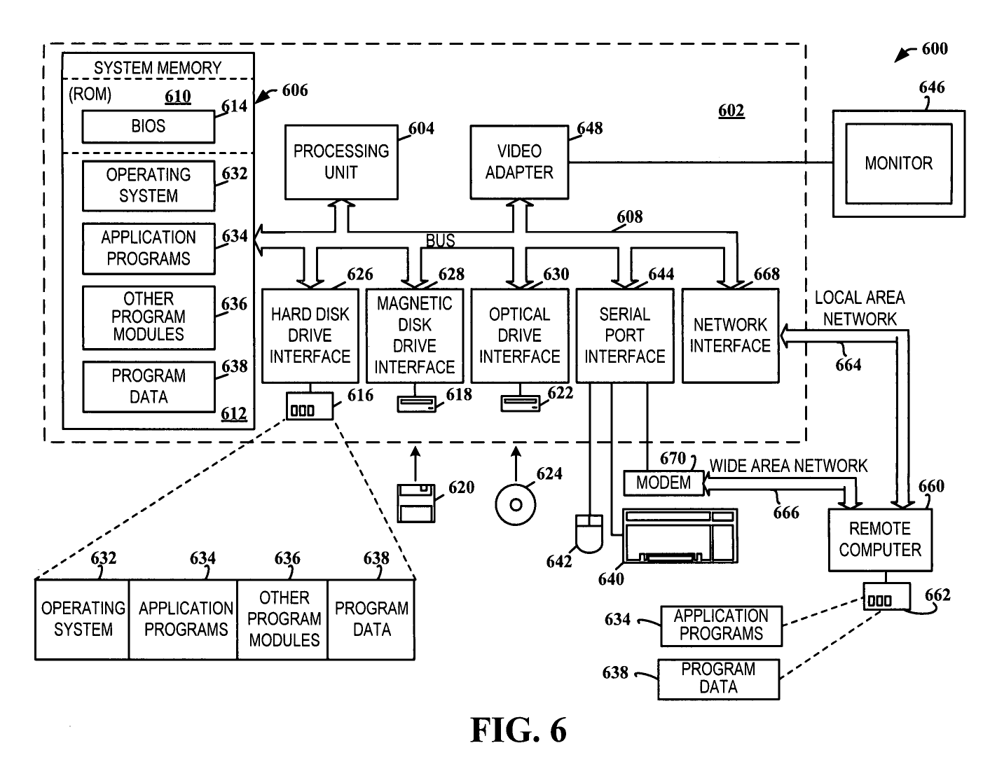

In order to provide additional context for implementing various aspects of the subject invention, FIG. 6 and the following discussion is intended to provide a brief, general description of a suitable computing environment 600 in which the various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents.

With reference to FIG. 6, an exemplary system environment 600 for implementing the various aspects of the invention includes a conventional computer 602, including a processing unit 604, a system memory 606, and a system bus 608 that couples various system components, including the system memory, to the processing unit 604. The processing unit 604 may be any commercially available or proprietary processor. In addition, the processing unit may be implemented as multi-processor formed of more than one processor, such as may be connected in parallel.

The system bus 608 may be any of several types of bus structure including a memory bus or memory controller, a peripheral bus, and a local bus using any of a variety of conventional bus architectures such as PCI, VESA, Microchannel, ISA, and EISA, to name a few. The system memory 606 includes read only memory (ROM) 610 and random access memory (RAM) 612. A basic input/output system (BIOS) 614, containing the basic routines that help to transfer information between elements within the computer 602, such as during start-up, is stored in ROM 610.

The computer 602 also may include, for example, a hard disk drive 616, a magnetic disk drive 618, e.g., to read from or write to a removable disk 620, and an optical disk drive 622, e.g., for reading from or writing to a CD-ROM disk 624 or other optical media. The hard disk drive 616, magnetic disk drive 618, and optical disk drive 622 are connected to the system bus 608 by a hard disk drive interface 626, a magnetic disk drive interface 628, and an optical drive interface 630, respectively. The drives 616-622 and their associated computer-readable media provide nonvolatile storage of data, data structures, computer-executable instructions, etc. for the computer 602. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 600, and further that any such media may contain computer-executable instructions for performing the methods of the subject invention.

A number of program modules may be stored in the drives 616-622 and RAM 612, including an operating system 632, one or more application programs 634, other program modules 636, and program data 638. The operating system 632 may be any suitable operating system or combination of operating systems. By way of example, the application programs 634 and program modules 636 can include an indication gateway scheme in accordance with an aspect of the subject invention.

A user can enter commands and information into the computer 602 through one or more user input devices, such as a keyboard 640 and a pointing device (e.g., a mouse 642). Other input devices (not shown) may include a microphone, a joystick, a game pad, a satellite dish, a wireless remote, a scanner, or the like. These and other input devices are often connected to the processing unit 604 through a serial port interface 644 that is coupled to the system bus 608, but may be connected by other interfaces, such as a parallel port, a game port or a universal serial bus (USB). A monitor 646 or other type of display device is also connected to the system bus 608 via an interface, such as a video adapter 648. In addition to the monitor 646, the computer 602 may include other peripheral output devices (not shown), such as speakers, printers, etc.

It is to be appreciated that the computer 602 can operate in a networked environment using logical connections to one or more remote computers 660. The remote computer 660 may be a workstation, a server computer, a router, a peer device or other common network node, and typically includes many or all of the elements described relative to the computer 602, although for purposes of brevity, only a memory storage device 662 is illustrated in FIG. 6. The logical connections depicted in FIG. 6 can include a local area network (LAN) 664 and a wide area network (WAN) 666. Such networking environments are commonplace in offices, enterprise-wide computer networks, intranets and the Internet.

When used in a LAN networking environment, for example, the computer 602 is connected to the local network 664 through a network interface or adapter 668. When used in a WAN networking environment, the computer 602 typically includes a modem (e.g., telephone, DSL, cable, etc.) 670, or is connected to a communications server on the LAN, or has other means for establishing communications over the WAN 666, such as the Internet. The modem 670, which can be internal or external relative to the computer 602, is connected to the system bus 608 via the serial port interface 644. In a networked environment, program modules (including application programs 634) and/or program data 638 can be stored in the remote memory storage device 662. It will be appreciated that the network connections shown are exemplary and other means (e.g., wired or wireless) of establishing a communications link between the computers 602 and 660 can be used when carrying out an aspect of the subject invention.

In accordance with the practices of persons skilled in the art of computer programming, the subject invention has been described with reference to acts and symbolic representations of operations that are performed by a computer, such as the computer 602 or remote computer 660, unless otherwise indicated. Such acts and operations are sometimes referred to as being computer-executed. It will be appreciated that the acts and symbolically represented operations include the manipulation by the processing unit 604 of electrical signals representing data bits which causes a resulting transformation or reduction of the electrical signal representation, and the maintenance of data bits at memory locations in the memory system (including the system memory 606, hard drive 616, floppy disks 620, CD-ROM 624, and remote memory 662) to thereby reconfigure or otherwise alter the computer system's operation, as well as other processing of signals. The memory locations where such data bits are maintained are physical locations that have particular electrical, magnetic, or optical properties corresponding to the data bits.

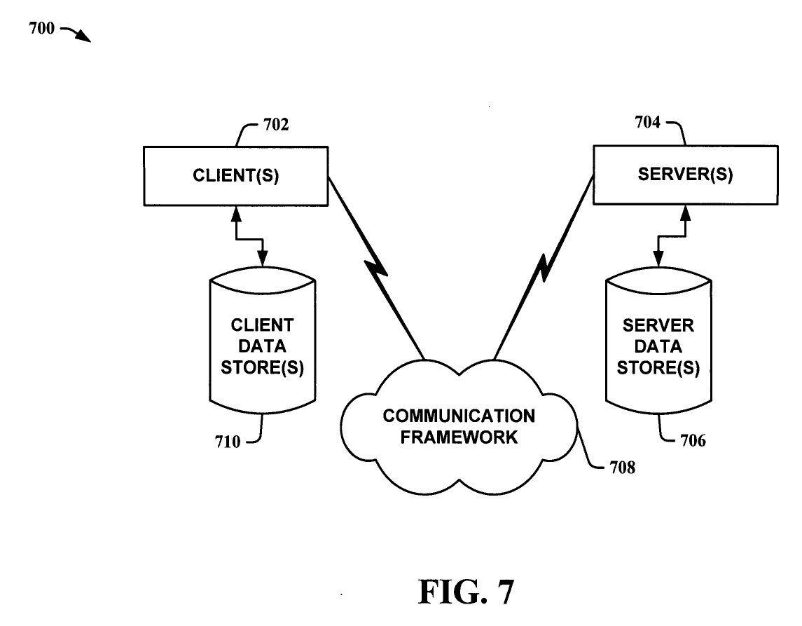

FIG. 7 is another block diagram of a sample computing environment 700 with which the subject invention can interact. The system 700 further illustrates a system that includes one or more client(s) 702. The client(s) 702 can be hardware and/or software (e.g., threads, processes, computing devices). The system 700 also includes one or more server(s) 704. The server(s) 704 can also be hardware and/or software (e.g., threads, processes, computing devices). One possible communication between a client 702 and a server 704 may be in the form of a data packet adapted to be transmitted between two or more computer processes. The system 700 includes a communication framework 708 that can be employed to facilitate communications between the client(s) 702 and the server(s) 704. The client(s) 702 are connected to one or more client data store(s) 710 that can be employed to store information local to the client(s) 702. Similarly, the server(s) 704 are connected to one or more server data store(s) 706 that can be employed to store information local to the server(s) 704.

It is to be appreciated that the systems and/or methods of the subject invention can be utilized in indication gateway facilitating computer components and non-computer related components alike. Further, those skilled in the art will recognize that the systems and/or methods of the subject invention are employable in a vast array of electronic related technologies, including, but not limited to, computers, servers and/or handheld electronic devices, and the like.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates evaluation of user interaction with an enticement, comprising:
a receiving component that receives an initial indication from a user in response to an interactive enticement; and
a gateway process component that responds to the initial indication and interacts with the user to elicit at least one subsequent indication before notification of the initial interaction to an entity associated with the interactive enticement.

2. The system of claim 1, the gateway process component determines a user's intent associated with the initial indication based on, at least in part, subsequent interactions with the user.

3. The system of claim 1, the gateway process component interacts with the user to facilitate in obtaining additional information, determining fraudulent activity, and/or providing buffering for the entity associated with the interactive enticement.

4. The system of claim 3, the buffering comprising funneled and/or redirected Universal Resource Locator (URL) links and/or server hosted information associated with the interactive enticement.

5. The system of claim 1 further comprising:
a pricing component that determines a monetary value of the initial and/or subsequent indications.

6. The system of claim 5, the pricing component employs an algorithm to determine pricing based on:
price=p₀n₀+p₁n₁+p₂n₂ (Eq.1)
where n₀ represents a number of interest enticements, n₁ represents a number of initial indications an enticement receives, n₂ represents a number of subsequent indications, p₀ represents a monetary value per enticement, p₁ represents a monetary value per initial indication, and p₂ represents a monetary value per subsequent indication.

7. The system of claim 1, the indications comprising mouse and/or keyboard clicks in response to a World Wide Web advertisement.

8. The system of claim 1, the enticement comprising an interactive advertisement displayed on a World Wide Web page.

9. A method of charging for user indications relating to an interactive enticement, comprising:
receiving an initial indication and at least one subsequent user indication that is obtained in response to an indication gateway component interaction; the indications relating to at least one interactive enticement relayed to at least one user; and
charging an entity associated with the interactive enticement based on, at least in part, the initial and/or subsequent user indications associated with the interactive enticement.

10. The method of claim 9, the indications comprising mouse and/or keyboard clicks associated with a World Wide Web advertisement.

11. The method of claim 9 further comprising:
charging the entity for user indications determined via indication gateway component buffering subsequent to the initial indication.

12. The method of claim 11 further comprising:
charging the entity for providing buffering of interactions by the indication gateway component.

13. The method of claim 12, the buffering comprising funneling and/or redirecting of user interactions.

14. The method of claim 9 further comprising:
obtaining additional information from the user in response to the initial indication; and
charging the entity for the information and/or charging the entity based on, at least in part, the initial and/or subsequent user indications associated with the enticement and the additional information.

15. A method of evaluating user indications subsequent to an initial indication, comprising:
receiving an initial indication in response to at least one interactive enticement relayed to at least one user;
providing buffered information from an entity associated with the interactive enticement; the buffered information provided to the user in response to the initial indication; and
tracking a user's interactions with the buffered information to determine user intent associated with the initial and/or subsequent indications relating to the interactive enticement.

16. The method of claim 15 further comprising:
utilizing the tracked interactions to facilitate in determining and/or preventing fraudulent activity.

17. The method of claim 16, the fraudulent activity comprising click fraud with regard to World Wide Web advertisements.

18. The method of claim 15 further comprising:
utilizing the tracked interactions to facilitate in determining a monetary value for the initial and/or subsequent indications relating to the interactive enticement.

19. The method of claim 15 further comprising:
interacting with the user via the buffered information to obtain additional information to facilitate in determining the user's intent associated with the initial and/or subsequent indications relating to the interactive enticement.

20. The method of claim 15, the buffered information comprising, at least in part, funneled and/or redirected information associated with the user's interactions.
